(19) United States
(12) Patent Application Publication
(10) Pub. No.: US 2010/0051353 A1
(43) Pub. Date: Mar. 4, 2010

(54) Child Growth Monitoring

(75) Inventor: Jeffrey Swan, West Chester, PA (US)

Correspondence Address: LEMPIA BRAIDWOOD LLC, One North LaSalle Street, CHICAGO, IL, 60602, US

(73) Assignee: Graco Children's Products Inc., Exton, PA (US)

(21) Appl. No.: 12/203,839

(22) Filed: Sep. 3, 2008

(51) Int. Cl. G01G 19/44

(52) U.S. Cl. 177/25.13

(57) ABSTRACT

A device for monitoring growth of a child includes a platform to support the child during a measurement of weight, a transducer coupled to the platform to generate an indication of the weight of the child, a controller configured to determine a timing of the weight measurement, a computer-readable medium in communication with the controller and configured to store data representative of the weight indication and the measurement timing, and a data output port coupled to the controller. The controller is further configured to incorporate the data in a data compilation representative of a set of measurements of the growth of the child for exportation of the data compilation via the data output port.

### BACKGROUND OF THE DISCLOSURE

1. Field of the Disclosure

The present disclosure is generally directed to monitoring child growth, and more particularly to the collection, dissemination and analysis of child growth data.

2. Description of Related Art

Height and weight measurements are routinely taken at regular intervals during a child's early years to monitor the progress of growth and development. While routine for virtually all babies, achieving suitable weight gain and growth can be a major issue confronting prematurely born babies. Weight gain is also widely monitored to provide an indication of how much nourishment a breastfed child is receiving. Tracking weight gain can also be central to weight management techniques involving obese children.

Monitoring the growth of a child often involves a comparison with a growth chart of national statistics for children at various ages. The statistics are compiled for each age (e.g., three months, six months, one year, etc.) to define percentiles or ranges into which a child is classified based on size measurements, such as weight, length, and head circumference. The statistics may also identify benchmarks or major milestones in growth and development. Analysis of the size measurements in view of the statistics can then form the basis for a variety of assessments, e.g., progress in weight gain, proportional development, etc.

Growth measurements underlying the growth chart analysis are typically made during a visit to a pediatrician or other physician. As a result, data is collected only occasionally or intermittently for the child, e.g., once per month.

Unfortunately, the monthly measurements can fail to provide information suitably representative of the growth of the child. The measurements may instead capture or reflect circumstances that led to, for instance, a temporary, transient or recent change in weight or size. For example, an illness such as the flu or a cold can cause a significant fluctuation in weight through dehydration or reduced caloric intake. Height measurements can reflect sudden or recent growth spurts experienced by the child. In these and other cases, the intermittent nature of the checkups provide occasional snapshots rather than comprehensive views of the growth of the child.

Nevertheless, a number of diagnoses and other decisions are commonly made based on these snapshot measurements. As a result, decisions may be made by physicians, and actions may be taken by caregivers, without the benefit of full information and knowledge of the child's growth and development.

### BRIEF DESCRIPTION OF THE DRAWINGS

Objects, features, and advantages of the present invention will become apparent upon reading the following description in conjunction with the drawing figures, in which:

FIG. 1 is a schematic view of one example of a digital scale configured in accordance with various aspects of the disclosure;

FIG. 2 is a block diagram of an exemplary electronic control unit of the digital scale of FIG. 1 in accordance with one embodiment;

FIG. 3 is a schematic diagram depicting a system and technique in which the digital scale of FIG. 1 is used for monitoring growth of the child in accordance with further aspects of the disclosure;

FIGS. 4-6 are exemplary user interface display panels of the digital scale of FIG. 1;

FIG. 7 is a flow diagram of an exemplary routine implemented by a microcontroller or microprocessor of the electronic control unit of FIG. 2 in accordance with one aspect of the disclosure; and

FIG. 8 is a flow diagram of an exemplary routine implemented by a remote server of the system of FIG. 3 in accordance with one aspect of the disclosure.

### DETAILED DESCRIPTION OF THE DISCLOSURE

This disclosure is generally directed to devices, systems, and methods for monitoring the growth of the child. As described below, the disclosed devices and techniques improve and enhance the availability and accessibility of data generated from growth measurements as well as the reference data with which the measurement data is compared. For example, the disclosed techniques can facilitate distribution and communication of the growth measurement data to physicians and other individuals not continuously available for data collection. The disclosed techniques can also aggregate or compile the growth data over time for a particular child. The compiled data may then be used in a variety of comparisons involving, for instance, growth chart statistics to avoid the limitations of infrequent snapshots in monitoring growth.

While described below in the context of a standalone digital weight scale, the disclosed techniques are well suited for use with a variety of different growth measurement techniques. For instance, the disclosed techniques primarily involve weight measurements, but may further involve a variety of other measuring devices. Thus, the disclosed techniques are not limited to any one type of measuring device or mechanism, or any one growth parameter or variable, in monitoring the growth of a child.

The disclosed devices and techniques generally address a number of user interface limitations typically presented with weight scales and other measuring devices. For instance, a data output port of the disclosed devices provides data access and portability. In this way, the disclosed devices and techniques address the challenge of providing a wide variety of user interface functionality. Thus, the data transfer and exportation aspects of the disclosed devices and techniques provide beneficial results and advantages in the support of a variety of input and data output functions.

The data exportation and other aspects of the disclosure also broaden the utility of the growth measurement data in unexpected and advantageous ways. In addition to use in connection with physician examinations, the measurement data can support the generation of instructional messages to provide guidance to caregivers. The measurement data may be useful, for instance, in determining when an infant car seat should be reoriented due to the growth of the child (e.g., from a rearward facing orientation to a forward facing orientation). The car seat determination can be rather complex, involving a number of different variables, including age, weight, and height. Based on the measurement data and other information (e.g., age, seat type, etc.), a content-specific alert message may be issued to the caregiver once a set of conditions are satisfied. Other growth-related messages may also be provided, including those directed to reconfiguring play yards, cribs and other infant items, or controlling access to certain play toys. Still further examples involve messages with content not necessarily related to guidance or instruction, yet still derived from the growth measurements (e.g., comparisons with the growth of siblings). More generally, the selection of the content made available via the disclosed devices and techniques may be driven by analysis of the data itself and/or based on user configuration settings.

The disclosed techniques also accommodate updates and other changes to growth chart data, as well as any other change to the data with which the measured data is compared. Over time, the growth chart data is updated to reflect the latest statistics. These updates may also include additional data sets for a variety of comparisons, including, for example, comparisons between siblings and other relatives, friends, children of friends, etc. More generally, the comparison data is easily customized, selected or modified, as desired. In this way, the disclosed devices and systems are dynamically adjustable rather than static, which can happen with other standalone devices.

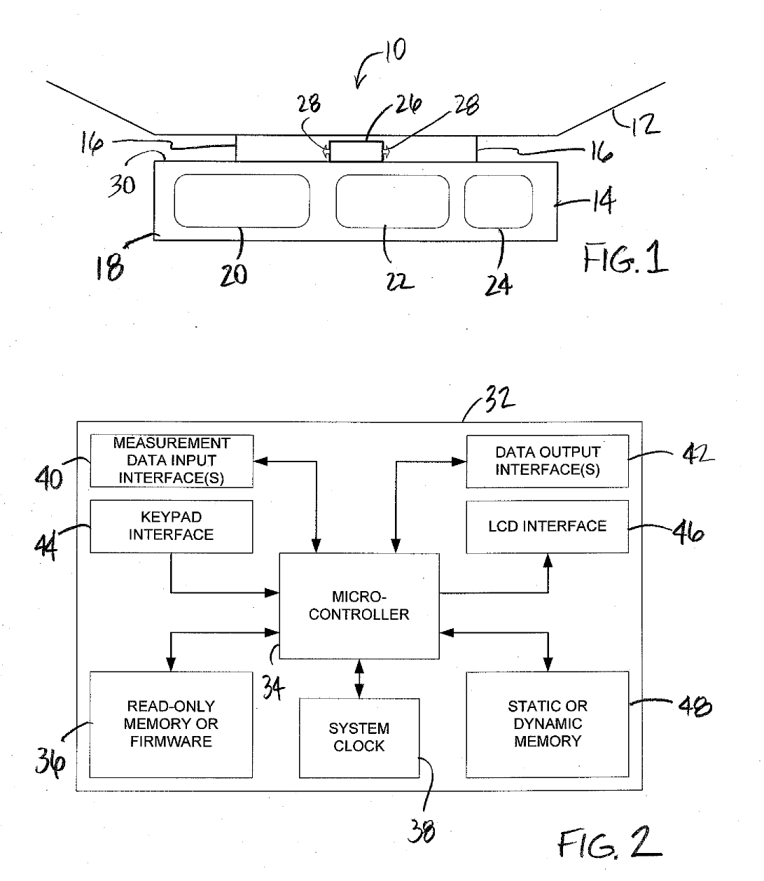

With reference now to the drawing figures, FIG. 1 depicts a digital scale indicated generally at 10 having a platform 12 upon which a child is supported. The platform 12 is, in turn, supported above a device housing 14 by one or more load cells 16. Each load cell 16 may include, for example, a strain gauge. More generally, each load cell 16 develops a signal or other indication of the weight or mass supported by the platform 12. The number, arrangement, and configuration of the load cells 16 may vary widely. Moreover, a variety of transducers other than load cells are suitable for use in connection with the disclosed techniques. The configuration of the device housing 14 and the structural details of the support of the platform 12 may also vary widely. For instance, the load cells 16 may be disposed within, or otherwise integrated with, the device housing 14 to any desired extent.

The device housing 14 contains a number of components responsive to the weight signal. Some of the components may be directed to measurement data collection (or data input), while other components are directed to measurement data dissemination (or data output). In accordance with one aspect of the disclosure, the device housing 14 has a number of user interface panels to facilitate the data collection and dissemination. In this example, the device housing 14 has a front face 18 upon which a display panel 20, an input interface panel 22, and an output interface panel 24 are mounted or disposed. The sizes, positioning and arrangement of the panels 20, 22, 24 may vary considerably. In other examples, one or more of the panels may be disposed on a different face or other portion of the housing 14. Other examples may also include additional panels directed to the same or similar purposes (e.g., data display, input and output). In some cases, one or more panels may be directed to more than one purpose. For instance, the display panel 20 may be a touch-sensitive display screen configured to detect user input actions. More generally, the panels 20, 22, 24 collectively provide functional interfaces for a user related to growth measurements, data dissemination, and data collection.

The display panel 20 may include an LCD readout or other display screen configured to convey a variety of status information and data. The amount of information and data may also vary, but in some cases may be rather limited, thereby relying on another aspects of the disclosed techniques for further dissemination of information. Some of the information conveyed may be directed to displaying the current measurement data as well as the current settings, or configuration, of the digital scale 10. For example, the display panel 20 may include a screen display section directed to displaying the current measured weight. A configuration setting may also be displayed to specify the unit of measure (e.g., metric) for the weight measurement. Further examples and details regarding the display panel 20 and the information conveyed thereby are set forth below. In general, however, the display panel 20 may include or utilize a variety of visual indicators or display technologies, ranging from a single LED or other illumination device for status and other indications to more complex displays involving various arrangements of sets of illumination sources or devices.

The input interface panel 22 may present any number of mechanisms for a user to select an option, enter information or data, initiate an action or function, or otherwise configure the digital scale 10. Examples of suitable user input mechanisms include keypads, user select buttons and other touch-sensitive elements. The user interface panel 22 may also support other techniques for user interaction with the digital scale 10. For example, the user interface panel 22 may include any number of input ports configured to receive or accept a card, cable, or other device (or component thereof) directed to providing information, data, commands, or other indications to the digital scale 10.

The output interface panel 24 is generally directed to disseminating or exporting data and information from the digital scale 10. To this end, the output interface panel 24 may include user interface elements configured to indicate information or data directly. Alternatively or additionally, the output interface panel 24 includes a number of output ports configured to receive a card, cable, or other device (or component thereof) capable of storing, carrying or otherwise delivering the data or information to be exported. For example, the output interface panel 24 may include a card slot to support the use of one or more types of memory cards. Another example includes or involve one or more ports to receive connectors (e.g., a cable tip) to couple devices to the digital scale 10.

In the example shown in FIG. 1, the digital scale 10 also includes a length measurement device 26 to facilitate height or length measurements while the child is on the platform 12. The length measurement device 26 may be configured in a variety of manners, and thus is depicted schematically in FIG. 1. The length measurement device 26 may include one or more extendable strips 28 to facilitate the measurement. For instance, the strips 28 may be configured to function as a pair of retractable tape measures. In that case, one or more internal sensors may be used to determine the extent to which the tape measurement strips 28 have been extended, thereby developing the length measurement. Alternatively, the tape measurement strips 28 may have markings to be read by a user. In still other examples, the length measurement device 26 may include a fixed or movable ruler. In each of these cases, the length measurement device 26 may be disposed at or near the platform 12, such as on the top surface 30 of the housing 14 as shown. In this manner, the length or height of a child can be quickly determined during or in conjunction with a weight measurement. Once the length or height of the child is determined, the length data is captured by the digital scale 10 through user input (e.g., via the input interface panel 22) or automatically via communication with the length measurement device 26.

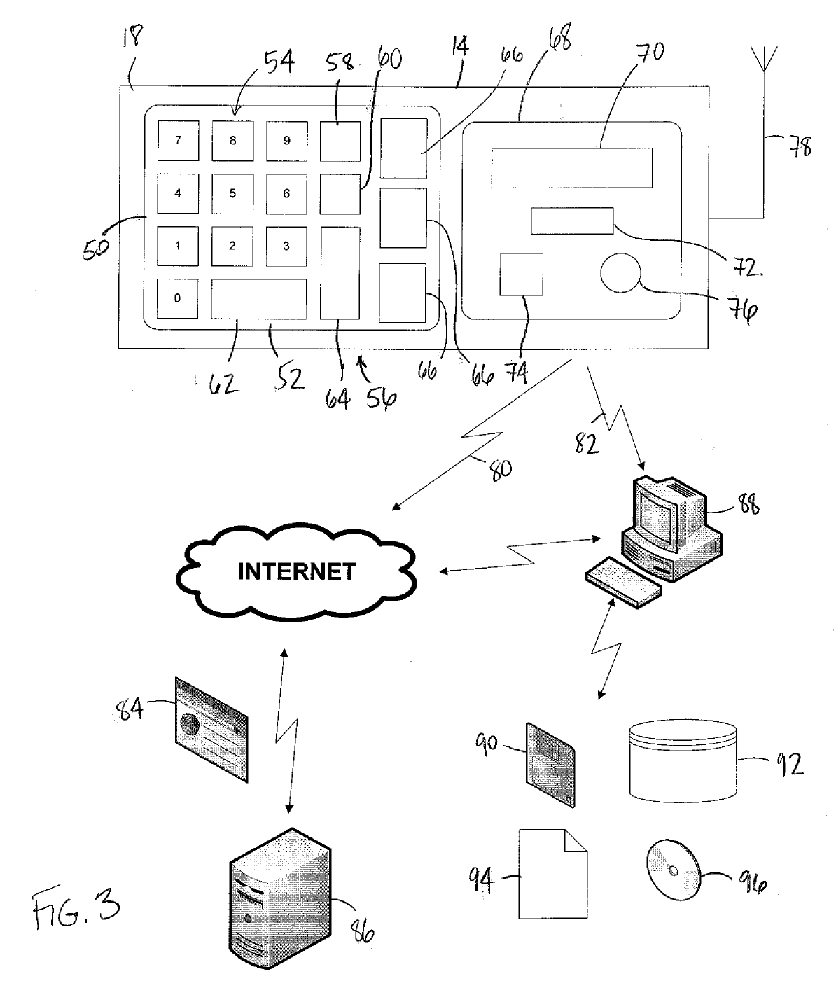

Turning now to FIG. 2, a control unit or controller 32 of the digital scale 10 coordinates and directs the operation and functionality of the user interface panels 20, 22, 24 and other components of the digital scale 10. The control unit 32 may include any number of electronic components integrated to any desired extent and connected in any conventional manner. In one example, some or all of the components of the control unit 32 are mounted and connected on a printed circuit board (PCB). Alternatively or additionally, some or all of the functionality of the control unit 32 is integrated in an application-specific integrated circuit (ASIC) or integrated circuit arrangement.

Generally speaking, the control unit 32 is configured to support and implement the data input and output functions of the digital scale 10, as well as any intermediate data processing and storage operations. To those ends, the control unit 32 may include a microcontroller or microprocessor 34 of any desired type and level of programmability. The microcontroller 34 may be configured to implement or direct the functions of the control unit 32 via hardware, software, firmware or any combination thereof. In this example, control software for the microcontroller 34 is stored on and accessed via a read-only memory (ROM) 36 or firmware (e.g., flash memory, EEPROM, SRAM, etc.), which may be integrated with the microcontroller 34 to any desired extent. Alternatively or additionally, the control unit 32 includes one or more general-purpose processors, digital signal processors or other processing circuits to implement the firmware, software or other device instructions.

The control unit 32 generally implements one or more functions that record measurement data in association with the timing of the measurements. To that end, the control unit 32 includes a system clock 38 in communication with the microcontroller 34. In operation, the microcontroller 34 obtains from the system clock 38 an indication of the current time or date for each measurement. The microcontroller 34 then records the measurement data in a storage medium in association with the measurement timing. In the example shown, the system clock 38 is a discrete component coupled to the microcontroller 34. However, the system clock 38 may alternatively be integrated with the microcontroller 34 to any desired extent, and thus is shown separately for ease in description. As with the other functions and tasks handled by the microcontroller 34, the system clock 38 may be implemented in hardware, software, firmware or any combination thereof. The functionality of the system clock 38 may be applied to any number of tasks or functions beyond the tracking and determination of the date on which measurement data is collected.

The control unit 32 includes any number of data input and output interfaces 40, 42 to facilitate data transfers or other communications. To this end, each interface 40, 42 may include data conversion, signal conditioning, and other communication functionality. These communications may be initiated or directed to, for instance, via the panels 22, 24 (FIG. 1). One or more of the input interface(s) 40 are directed to data transfers or communications of measurement data. In this example, all of the input interfaces 40 handle the incoming measurement data, while a separate interface 44 may be provided to support other communications, like those originating via a keypad or other set of user interface elements of the panel 22. In such cases, the data input interfaces 40 may then be configured specifically for communication with a measurement sensor, such as a load cell or other transducer. For example, one or more of the data input interfaces 40 may include an analog-to-digital converter to translate a signal generated by the measurement sensor into a digital representation thereof. The keypad interface 44, in contrast, may not need to implement any data conversion, but rather address other signal conditioning or voltage regulation preferences.

The data output interfaces 42 are generally configured to facilitate data exportation via the panel 24 (FIG. 1). To that end, each data output interface 42 may include respective circuitry to convert, condition or otherwise prepare the digital representations of the data provided by the microcontroller 34. For example, one of the data output interfaces 42 may be configured to condition the digital data stream from the microcontroller 34 for transmission in accordance with a communication protocol for a particular output port (e.g., a Universal serial bus (USB) port).

In this example, a separate output interface 46 is provided to control the LCD display screen or other display panel 20. The LCD interface 46 may, for example, include an array of switches or other control elements to regulate or direct the illumination of respective elements of the display panel 20 in accordance with control signals from the microcontroller 34.

The control unit 32 may also include one or more units of static or dynamic memory 48 to store a variety of types of data and information utilized, processed or generated by the microcontroller 34. Measurement data collected via the data input interfaces 40 may be stored in the memory 48 after processing, if any, by the microcontroller 34. Configuration settings selected by a user via the panel 22 (FIG. 1) may also be stored in the memory 48. The operational characteristics (e.g., volatile or non-volatile) and structural configuration (e.g., SRAM, DRAM, EPROM, EEPROM, etc.) of the memory 48 may vary widely, and a variety of physical arrangements may be utilized as desired (e.g., chip, flash, card, etc.). In some examples, some or all of the memory 48 is integrated with the microcontroller 34.

FIG. 3 depicts a portion of the front face 18 the housing 14 in greater detail. In this exemplary case, a panel 50 includes a keypad 52 with a 0-9 numeric keypad section 54 and a command selection section 56. The keypad section 54 includes respective user select buttons for each of the numerals available for selection. Alternatively or additionally, the keypad 52 includes user select buttons for incrementing and decrementing a value currently displayed via, for instance, the display panel 20. The command selection section 56 includes further user select buttons dedicated to corresponding commands available for selection. For example, a user select button 58 may be dedicated to selecting a child from a set of children for which data has been stored or captured. In some cases, the user select button 58 may work as a toggle switch, in the sense that repeated actuation of the button 58 toggles the child selection to the next child available. Another user select button 60 may be directed to selecting a gender for a child to be measured, and may also work in a toggling fashion. Further user select buttons 62 and 64 may be dedicated to initiating a data capture operation or a data transfer operation, respectively. Actuation of one of the user select buttons 62 or 64 results in the implementation of a corresponding function or operation by the control unit 32 (FIG. 2).

User select buttons 66 may provide a user with navigation functionality (e.g., left and right, up and down, or both) and selection functionality (e.g., enter, OK, and the like). The navigation and selection functionality supports interaction with the display panel 20 (FIG. 1). More specifically, a cursor or other movable indicator on the display panel 20 can be directed to highlight various icons using the navigation buttons. Once a desired icon is highlighted, the user can implement an associated procedure or operation using the select (e.g., enter, OK, etc.) button. Alternatively or additionally, the user select buttons 66 may be used to select among available data transfer options, such as determining which output port is to be used or active. A variety of other uses or purposes may be designated for the user select buttons 66, as desired. Furthermore, the purpose, arrangement and number of user select buttons may vary considerably from the example shown and described above.

An output panel 68 is disposed adjacent the panel 50 in this example to provide a set of data export options to the user. Generally, the panel 68 includes one or more interfaces to accommodate data export operations. In this example, the panel 68 includes a memory card slot 70, a universal serial bus (USB) port 72, an optical drive port 74, and a printer port 76. The type, number, arrangement, and configuration of the ports 70, 72, 74, 76 is exemplary in nature, and may vary widely to accommodate any transmission format, protocol, or technique, as well as any transmission or storage medium. For example, in an alternative embodiment, the drive port 74 is configured to support the connection of a device that writes and reads magnetic disks rather than optical disks. As with the memory card slot 70, the read/write functionality (and any device) associated with any of the output techniques may be integrated within the housing 14, such that the corresponding port forms a slot in which a memory card or other element can be received. In some cases, any one of the ports may be configured to accommodate multiple data output techniques, such as a printing operation, a wireless transmission, a data storage operation, etc. To those ends, the microcontroller 34 (FIG. 2) and/or the corresponding output interface 42 (FIG. 2) may be configured with a device driver (or other protocol information) via software, firmware, etc. to support communications with the device(s). The USB port 72 is one example of an output interface capable of supporting communications with a variety of devices, including, for instance, flash memory devices, printers, handheld computers, and wireless communication devices.

The output panel 68 may also be configured to support data communications and transfers via a variety of techniques and protocols. To that end, any of the ports or slots made available via the output panel 68 may be used to establish a communication link or connection. In the example shown, an antenna 78 is made available for establishing wireless communications via any desired protocol (e.g., IEEE standard 802.11). Alternatively or additionally, a communication device (not shown) may be inserted into a slot or port of the output panel 68, such as the USB port 72, to provide an antenna to support wireless communications of a different or additional protocol. In these ways, the nature of the communication link or connection may vary widely. Moreover, the communication link need not be wireless, but instead involve one or more cables or wires connecting the output panel 68 to an external device or system. Still further, the communication link may be established via a portable storage device, such as a memory card configured for insertion in the slot 70 of the output panel 68.

Communication links 80, 82 schematically depict the transfer of data and information from the digital scale 10 to several exemplary devices and systems. In the example shown in FIG. 3, the communication link 80 is indicative of data transfer via a network, such as a local area network (LAN), wide area network (WAN) or Internet. In one example, the network data transfer may lead to storage of the data or information in a database 84 hosted by a server 86. The examples shown in connection with the communication link 82 provide instances of communication transfers to a computer 88. Again, the manner in which the computer 88 is connected, if at all, to the output panel 68 may vary considerably. Exemplary connections include a USB cable, an Ethernet cable, and a wireless link (e.g., IEEE standard 802.11). The communication link 82 may also include or involve a memory storage device, as described above. Once the data or information has been exported to the computer 88, software resident on the computer 88 may then be used to effectuate further transfer or storage operations to, for example, portable magnetic storage media 90, a database 92, a printed document 94, or optical media 96. As described below, each of these options may further support the dissemination and analysis of the data captured by the digital scale 10. In this way, the weight data and other growth information can easily be shared with, for instance, a family physician.

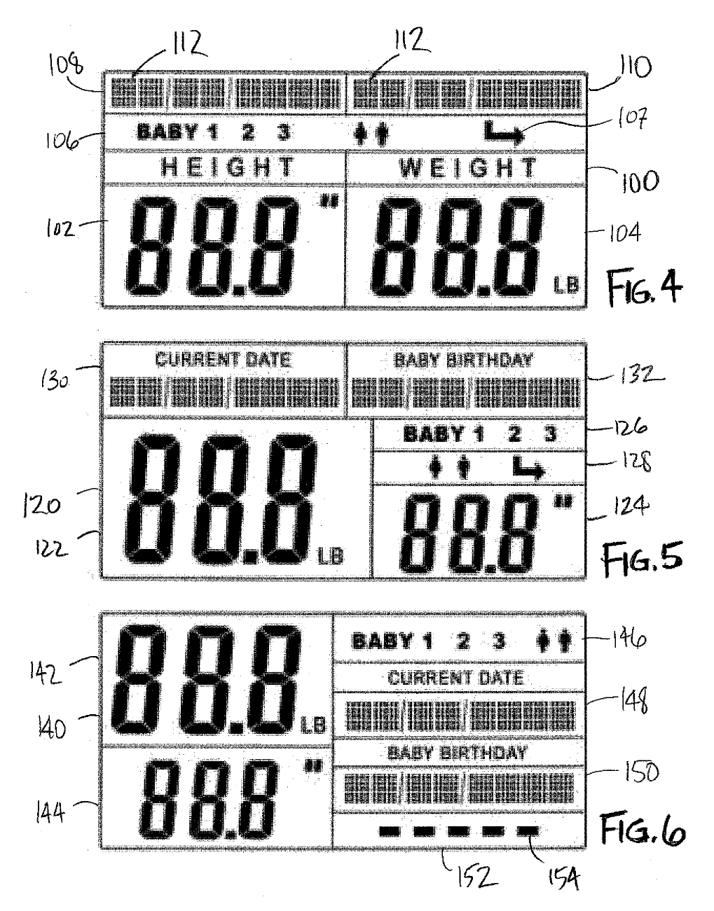

Further details regarding the operation of the digital scale 10 and the functionality of the control unit 32 are set forth in connection with the exemplary user interface displays depicted in FIGS. 4-6. Each of the exemplary displays may correspond with the display panel 20 (FIG. 1), or any portion thereof. In these examples, the digital scale 10 collects both height and weight data for multiple children identified by a numeral (e.g., 1, 2 or 3) and the birthday of the child.

Turning to FIG. 4, a user interface display 100 includes a height section 102 and a weight section 104 for displaying indications of the measured height and weight for a child. A child selection section 106 provides an indication of the child for which measurements are being captured. To that end, the child selection section 106 may include a list of numerals associated with children for which the digital scale 10 has been configured to capture information. The list of numerals may be continuously displayed in the child selection section 106, while the current child selection is indicated via, for example, underlining, bolding or other illumination highlighting. The child selection section 106 also includes an indication of a child gender, via illumination highlighting of an icon. Alternatively, the current child selection may be identified via a display of the child's name or any other identifying information. Data to support such identifications may be entered or provided to the digital scale 10 in a wide variety of ways, including, for instance, the panel 50 (FIG. 3).

The user interface display 100 may provide an option to initiate a downloading or other data export operation. In this exemplary case, the user interface display 100 includes an icon 107 in the shape of an arrow. The user can highlight and select the icon 107 using the navigation and other buttons 66 (or some other user interface element) to initiate the downloading operation. The operation may, for instance, proceed to transfer the data to a default port, a currently active port, a currently selected port, a port having a memory card, a port to be determined, etc.

In this example, a pair of date sections 108, 110 are disposed above the child selection section 106. The date section 108 may specify the birthday of the currently selected child, while the date section 110 may specify the current date. Each of the sections 108, 110 includes a set of two- or four-digit spaces 112 in which the respective dates are identified via numerals in, for instance, a standard format involving numeral representations arranged as follows: month/day/year.

Notwithstanding the foregoing example, some embodiments need not operate with knowledge of the current calendar date. For example, in some cases, the device may utilize date and time information relative to a birthdate. In this way, the date or time information stored in connection with a measurement may be indicative of timing relative to a birthdate.

FIG. 5 depicts an alternative user interface display 120 having height and weight sections 122, 124 arranged in a different layout involving varying sizes. In this case, the size of the height section 124 is reduced to allow child selection sections 126, 128 to fit in an adjacent location above the height section 124. In this example, a current date section 130 and a child birthday section 132 are labeled and arranged as shown, but otherwise configured in a manner similar to that described above in connection with the sections 108, 110 of the display 100.

FIG. 6 depicts another exemplary layout or arrangement of the various user interface sections. Specifically, a user interface display 140 has weight and height sections 142, 144 vertically oriented with regard to one another, and in contrast to the examples described above. The remaining sections of the user interface display 140 are arranged vertically in an adjacent column. In this example, a child selection section 146 is disposed above date sections 148 and 150. A status section 152 is located beneath the date section 150, and may be configured to display a moving indicator(s) to show progress toward the completion of an operation and/or an “in-progress” status. For example, the status section 152 may display a number of bars 154 representative of the degree of progress toward the completion of an operation, or the amount of time remaining to complete an operation.

The foregoing examples of user interface display are provided with the understanding that they are exemplary in nature. The layout, arrangement and content of the displays may vary considerably from that shown and described above.

As shown in the exemplary user interface displays described above, the amount of child growth information that can be conveyed on the scale itself is limited in many cases by the size, resolution and other characteristics of its display panel. The size of the display panel may be limited to a considerable extent by the dimensions of the scale. The characteristics of the display panel, in turn, may be limited or otherwise dictated by cost or manufacturability considerations. For example, the display panel may only include a moderately sized LCD panel to minimize manufacturing costs and maintain a desired form factor. Unfortunately, with an LCD panel, it can be difficult, if not impossible, to present details regarding the growth measurement history of the child, much less plot or otherwise graphically depict such details. In most cases, however, plots, charts or graphs are the most direct and informative way to portray the analysis of the growth history relative to the national statistics.

For these and other reasons, one aspect of the disclosure involves the control unit or controller described above being configured to incorporate the measurement data in a data compilation representative of a set of measurements of the growth of the child for exportation of the data compilation via the data output port. After the measurement data is captured or entered, the controller determines the timing of the measurement and stores the measurement and timing data in any of the computer-readable media described above. The storage operation may involve compilation with previous measurement and timing data. Alternatively, the compilation may occur at some point after the storage operation. For instance, the compilation may occur upon a request for data export. Eventually, the data compilation is exported via the data output port to a computer-readable medium external to the digital scale to facilitate more convenient viewing and access to the data.

The growth measurement data need not be captured or obtained via the same device. In some cases, some or all of the growth measurement data may be captured or gathered separately from, for instance, the weight measurements. In these and other cases, the measurement data may be entered via an input panel as described above or via a computer (or other device) having access to the remainder of the measurement data. In that way, the above-described compilation of the data can still occur, albeit involving multiple or varying sources.

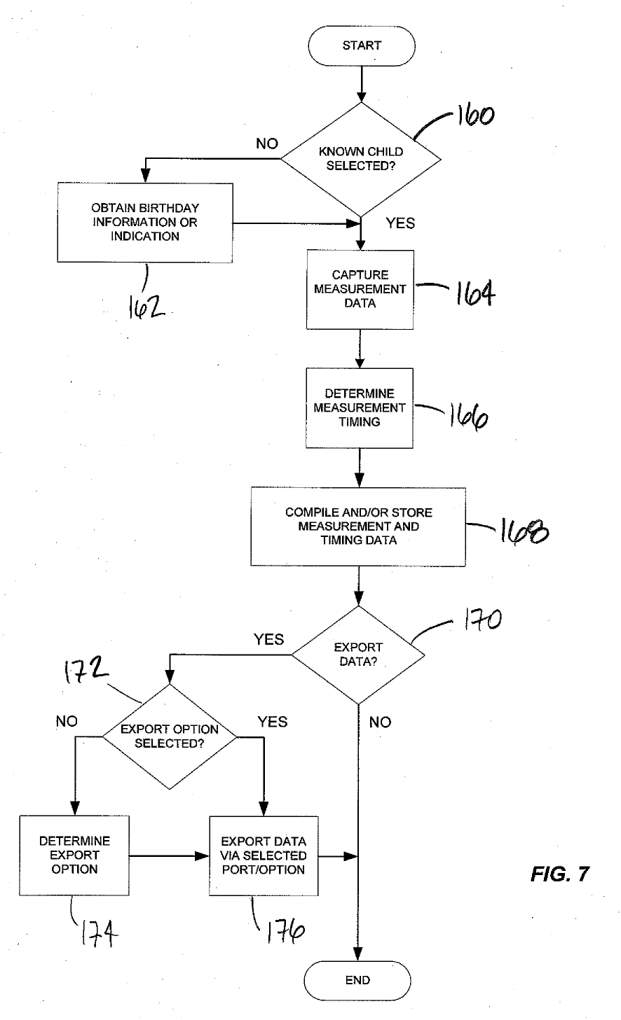

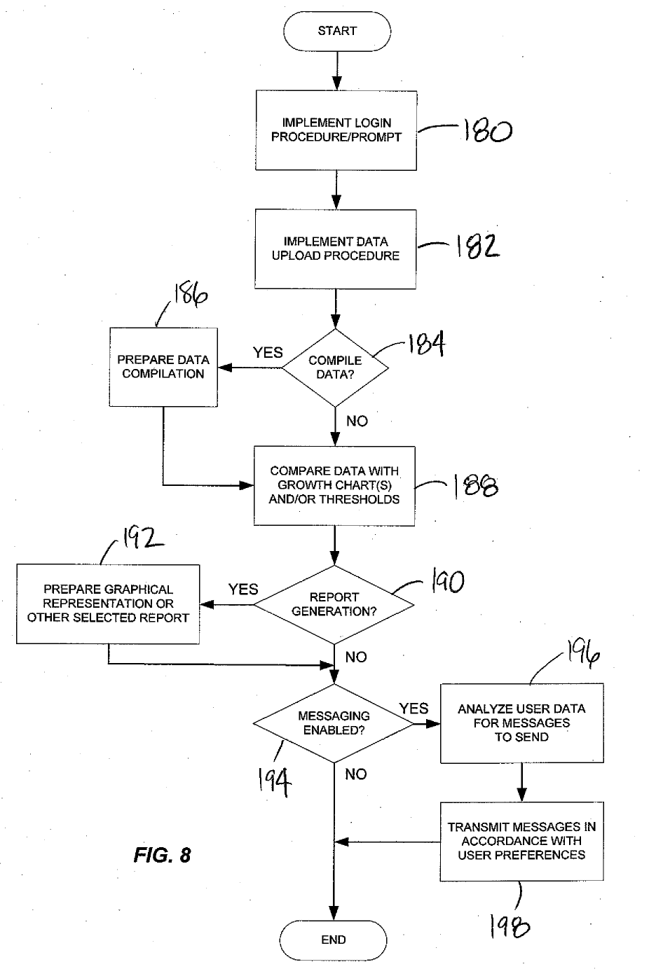

FIG. 7 depicts one example of a routine that may be implemented by the microcontroller or microprocessor 34 in connection with the monitoring of the growth of a child with the disclosed devices and systems. At the outset, the routine determines in a decision block 160 whether a known child is currently active or selected. A child is known when information regarding the child is stored in the memory 48. The information may be as simple as a name or other indication (e.g., child no. 1, etc.), and/or a birthday or age of the child. With knowledge of the birthday, timing information for each measurement can be determined. Then each measurement data point can be associated with a day or week relative to the birthday. Thus, the birthday may, but need not, be an absolute date (e.g., Jul. 11, 2004), and instead may be a relative date (e.g., 13 weeks from the first data collection in week 6 of a child's life).

If no child is selected, control passes to a block 162 to gather the supporting information for the growth measurements. For instance, the microprocessor may be directed to obtaining a name or other indication to be exclusively used to reference the child. The absolute or relative birthday or age information is then obtained and stored in association with the name indication. To these ends, the microprocessor may direct the user interface to prompt the caregiver to enter the information via one or more of the panels described above.

Once the supporting information is gathered or otherwise determined to be available, control passes to a block 164 that facilitates the collection of measurement data. Specifically, the microprocessor may direct the user interface to prompt the user to place the child on the scale so that the weight measurement can be captured. Other user interface prompts may be directed to capturing the other growth measurement data, such as height or length. Implementation of the block 164 may be directed to capturing any number of measurement data points or sets. After one or more measurement data points are captured, control eventually passes to a block 166 in which the microprocessor determines timing information for the captured measurement data. The microprocessor may then compile and/or store the measurement and timing data with data previously captured for the child in a block 168.

The microprocessor may be directed to export captured data at any point in the procedure, as shown in the example of FIG. 7 by a block 170. The data export operation may vary considerably, as described above. In some cases, the microprocessor initiates the operation by determining in a block 172 whether a specific type of data export is selected or active. If not, control passes to a block 174 to determine which one of the options should be used. For example, the block 174 may involve prompting the user to select one of the export options. Eventually, a data export option is determined, and control passes to a block 176 in which the microprocessor proceeds with exporting the data in accordance with the protocol(s) and parameters of the selected option.

Further aspects of the disclosure are directed to the processing of the data after an export operation has delivered the measurement and timing data to a central, networked or otherwise remote server. These data processing aspects of the disclosure are accordingly not limited to use with a specific digital scale, such as the one described above, and instead may utilize any measurement device to gather information to be provided to a network information processing center for analysis. In accordance with this aspect of the disclosure, a plurality of measurement data sets for the child are received via a network, with each measurement data set having a respective growth measurement and a corresponding timing indication for the respective growth measurement. Generally speaking, a computer-executable routine is then implemented to process the plurality of measurement data sets for one or more subsequent uses, operations or functions. In some cases, the data sets are used to generate a data compilation for a graphical representation of the growth of the child. The data compilation may then be processed to facilitate generation of the graphical representation by an end user (e.g., a plot or chart of the growth of the child). Alternatively or additionally, the data compilation may be used to support non-graphical representations of the growth of the child.

In accordance with another aspect of the disclosure, the compiled data may be analyzed to support the selection of content for distribution or delivery to the end user. Such analysis may include, for example, analyzing at least one measurement data set to select a message for a caregiver with recommendations, instructions, etc. based on the analysis. In one example, the instructional message may involve details regarding the re-orientation or reconfiguration of a child car seat, stroller, crib, etc., due to the growth of the child past a threshold. In another example, the instructional message may involve when to stop using a product, such as a bassinet, and/or when to begin using another product, such as a crib or toddler bed.

FIG. 8 presents an exemplary procedure for supporting these networked aspects of the disclosure. In this case, a server or other remote processor, such as the server 86 (FIG. 3), is accessed via a network, resulting in the implementation in a block 180 of a login or other initialization procedure. To this end, the server may prompt the user for access and/or security information. The login, user access and security information may also include or be indicative of the child with which the data is associated. Once the user (and/or child) is authenticated, the user or the server may then initiate in a block 182 the implementation of a data uploading procedure. Generally speaking, the measurement and timing data is then gathered or received via the network connection or communication link established with the server. A decision block 184 then determines whether the uploaded data needs to be compiled with previously uploaded data for the child. If yes, control passes to a block 186 for the preparation of a data compilation for the child. In this case, control eventually passes to a block 188 in which the server processes the compiled data for the child in a comparison with growth chart data and any number of growth thresholds or milestones.

After the data compilation and processing is completed, the server is then generally configured to support the generation of a representation of the results of the comparison and processing. In this example, a decision block 190 determines whether the representation of the results should include the generation of a report. In some cases, the report may present the data in connection with the growth chart data. More generally, the representation of the growth of the child may take any form, including graphical and non-graphical exhibits or reports. In some cases, the user may be provided with an option to select one or more of a plurality of available reports, graphs and other representations of the data. If a report is desired, control passes to a block 192 in which the selected report is generated or prepared. In one example, the measurement and timing data for the child is plotted on a graph with the growth chart data. The graph may plot both actual data as well as predictive data involving projections based on the actual data.

The example of FIG. 8 also includes further processing of the data compiled for a child. This processing is generally directed to determining content to be delivered or distributed to the user based on an analysis of the uploaded data. To that end, one or more measurement data sets of the data compilation may be analyzed by the server to determine whether any message is appropriate for distribution. In this example, a decision block 194 determines whether the user has enabled this messaging functionality and the underlying analysis. If so, control passes to a block 196 for the analysis of the data. Depending on the data, any number of messages, instructions, reminders or other content items may be determined to be appropriate. A block 198 then transmits the content item(s) to the user in accordance with any parameters or preferences specified by the user. For example, the content item(s) may be displayed via a website and/or delivered in an email communication.

Still other examples of content to be delivered include reminders sent via email to the caregiver based on one or more previous data upload operations. For example, an email communication may be generated and sent to convey a message regarding the number of days or weeks since the last data upload operation. In these cases, the implementation of the messaging functionality need not be triggered by an upload operation immediately preceding the analysis, as shown in FIG. 8. Instead, the data processing steps depicted in the example of FIG. 8 may be implemented by the server regardless of whether a communication link with the server is currently established.

Although certain devices, systems and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A device for monitoring growth of a child, the device comprising:
a platform to support the child during a measurement of weight;
a transducer coupled to the platform to generate an indication of the weight of the child;
a controller configured to determine a timing of the weight measurement;
a computer-readable medium in communication with the controller and configured to store data representative of the weight indication and the measurement timing; and,
a data output port coupled to the controller;
wherein the controller is further configured to incorporate the data in a data compilation representative of a set of measurements of the growth of the child for exportation of the data compilation via the data output port.

2. The device of claim 1, wherein the computer-readable medium comprises a dynamic memory coupled to the controller.

3. The device of claim 1, further comprising a housing having the data output port and a communication interface coupled to the data output port, and wherein the computer-readable medium comprises a portable storage device configured to be received within the data output port for engagement with the communication interface.

4. The device of claim 3, wherein the portable storage device comprises a flash memory device.

5. The device of claim 3, wherein the data output port is configured as a USB port.

6. The device of claim 1, further comprising a length measurement unit arranged relative to the platform to facilitate a measurement of length of the child while the child is supported by the platform.

7. The device of claim 6, further comprising a user interface in communication with the controller to gather information regarding the length measurement.

8. The device of claim 1, further comprising a user interface directed by the controller to depict an identification of the child.

9. The device of claim 1, further comprising a user interface directed by the controller to depict an identification of a birthdate for the child.

10. A method of monitoring growth of a child with a digital scale having a user interface, the method comprising the steps of:
capturing an indication of the birthday of the child via the user interface of the digital scale;
capturing an indication of weight using the digital scale during a measurement;
determining a timing of the measurement based on the captured birthday indication;
storing data representative of the weight indication and the measurement timing in a computer-readable medium of the digital scale; and
exporting the stored data via a data output port of the digital scale to a computer-readable medium external to the digital scale.

11. The method of claim 10, wherein the exporting step comprises transferring the data via a network to facilitate processing of the data for tracking the growth of the child.

12. The method of claim 11, further comprising the step of comparing the stored data with a growth chart.

13. A method for monitoring growth of a child, the method comprising the steps of:
receiving via a network a plurality of measurement data sets for the child, wherein each measurement data set comprises a respective growth measurement and a corresponding timing indication for the respective growth measurement;
implementing a computer-executable routine to process the plurality of measurement data sets to generate a data compilation for a representation of the growth of the child;
transferring the data compilation to facilitate generation of the representation by an end user; and
selecting content to be provided to the end user based on an analysis of at least one measurement data set of the plurality of measurement data sets.

14. The method of claim 13, wherein the implementing step comprises the step of comparing the plurality of measurement data sets with growth chart data.

15. The method of claim 13, wherein the selecting step comprises the steps of projecting future growth of the child based on the data compilation such that the content is based on the projected future growth of the child.

16. The method of claim 13, wherein the representation comprises a graphical representation.
